(19) United States
(12) Patent Application Publication
(10) Pub. No.: US 2010/0182072 A1
(43) Pub. Date: Jul. 22, 2010

(54) PATCH PANEL

(75) Inventor: HSING-CHANG LIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/406,069

(22) Filed: Mar. 17, 2009

(30) Foreign Application Priority Data
Jan. 16, 2009 (CN) 200910300230.9

(51) Int. Cl. G05F 1/00

(52) U.S. Cl. 327/518

(57) ABSTRACT

A patch panel includes a connector, a first switch circuit, a number of output circuits, a number of output terminals, and a complex programmable logic device (CPLD). The CPLD is capable of receiving a control signal from a controller via the connector, and sending the control signal to one of the output terminals via the first switch circuit, for signaling the controller to communicate to a peripheral device connected to the output terminal.

### BACKGROUND

1. Technical Field

The present disclosure relates to patch panels, and particularly, to a patch panel supporting communications between a controller and a plurality of peripheral devices.

2. Description of Related Art

At present, a controller communicates with a peripheral device through an input/output circuit board arranged in the controller. The input/output circuit board is connected to the peripheral device via a wire for transmitting signals between the controller and the peripheral device. It is common that a controller may need to communicate with many peripheral devices, which requires more input/output circuit boards. The added input/output circuit boards are costly, furthermore, wiring between the control and the input/output circuit boards is complex and difficult to achieve.

### BRIEF DESCRIPTION OF THE DRAWINGS

FIG. 1 is a schematic diagram of an embodiment of a patch panel.

FIG. 2 is an inverted view of FIG. 1.

FIG. 3 is a side elevational view of the patch panel of FIG. 1.

FIG. 4 is a partial circuit diagram of an embodiment of the patch panel of FIG 1.

FIG. 5 is another partial circuit diagram of the patch panel of FIG. 4.

### DETAILED DESCRIPTION

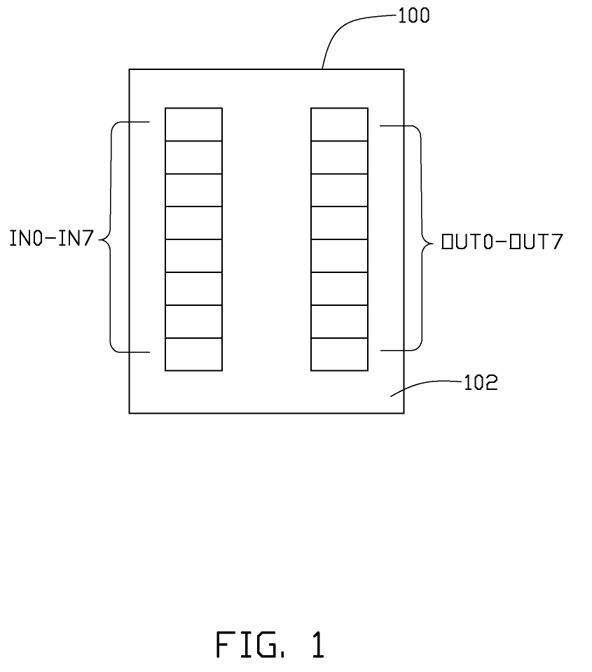

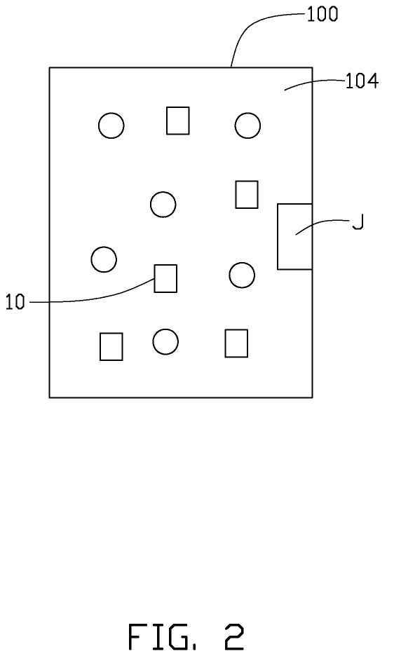

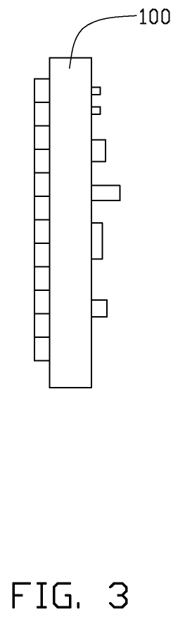

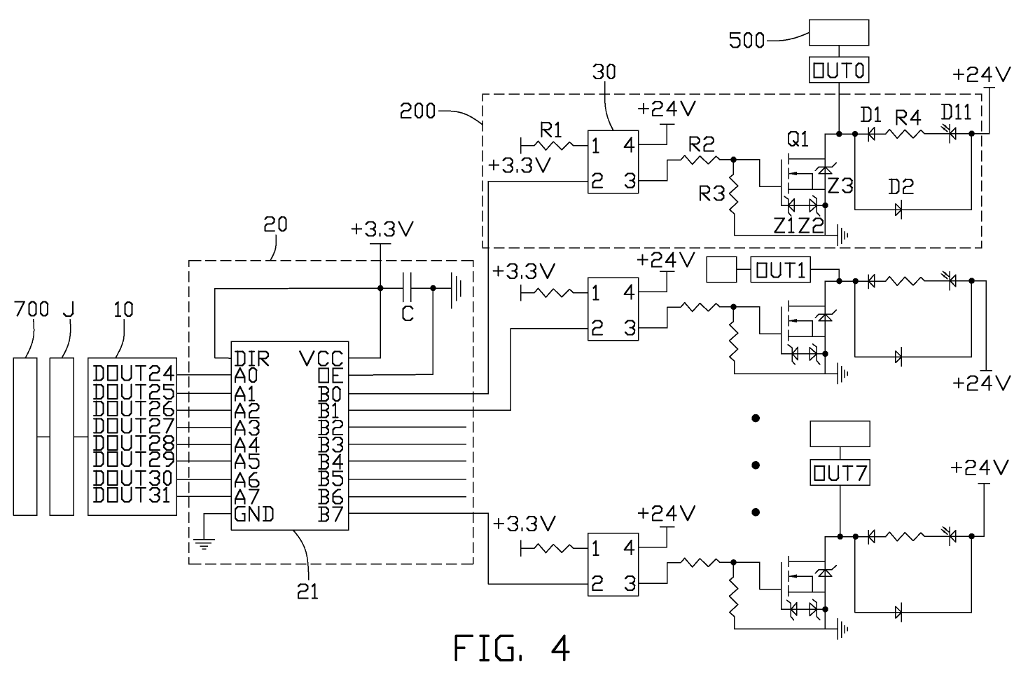

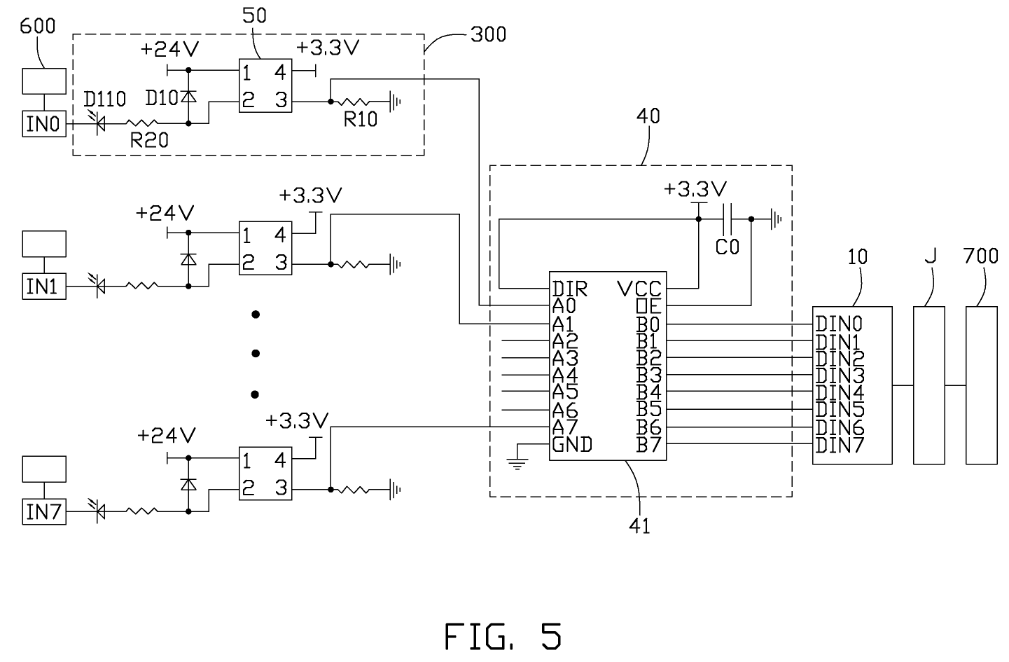

Referring to FIG. 1 through FIG. 5, an exemplary embodiment of a patch panel includes a base board 100. The base board 100 includes a connector J, a complex programmable logic device (CPLD) 10, two switch circuits 20 and 40, eight output circuits 200, eight output terminals OUT0-OUT7, eight input circuits 300, and eight input terminals IN0-IN7. In other embodiments, the number of the input circuits, the output circuits, the input terminals, and the output terminals can be changed according to need.

The base board 100 includes a first side surface 102, and a second side surface 104 opposite to the first side surface 102. The input terminals IN0-IN7 and the output terminals OUT0-OUT7 are set on the first side surface 102 of the base board 1 00. The connector J, the CPLD 10, elements of the switch circuits 20 and 40, and elements of the output circuits 200 and the input circuits 300 are set on the second side surface 104 of the base board 100.

Input pins of the CPLD 10 are connected to corresponding pins of the connector J. The CPLD 10 is connected to the output circuits 200 via the switch circuit 20. Each of the output circuits 200 is connected to a corresponding output terminal of the output terminals OUT0-OUT7. Each of the output terminals OUT0-OUT7 is configured to be connected to a peripheral device 500, such as a switch. The CPLD 10 is also connected to the input circuits 300 via the switch circuit 40. Each of the input circuits 300 is connected to a corresponding input terminal of the input terminals IN0-IN7. Each of the input terminals IN0-IN7 can be connected to a peripheral device 600, such as a sensor. When the patch panel is connected to a controller 700 via the connector J, the peripheral devices 500 and 600 can communication with the controller 700. For example, the controller 700 may send a control signal to the switch for controlling the switch to open or close, or receive a output signal from the sensor.

The switch circuit 20 includes a switch chip 21 and a capacitor C. Input pins A0-A7 of the switch chip 21 are connected to output pins DOUT24-DOUT31 of the CPLD 10. A ground pin GND and an output enable pin OE of the switch chip 21 are grounded. A voltage pin VCC of the switch chip 21 is connected to a +3.3V power source. An enable pin DIR of the switch chip 21 is connected to the +3.3V power source. A connection node between the voltage pin VCC and the enable pin DIR is connected to the ground via the capacitor C. Each of output pins B0-B7 of the switch chip 21 is connected to a corresponding output circuit 200. It may be understood that the voltage of the power source may be varied depending on the embodiment.

Each of the output circuits 200 includes a photocoupler 30, four resistors R1-R4, a field effect transistor (FET) Q1, three voltage regulating diodes Z1-Z3, two diodes D1 and D2, and a light emitting diode (LED) D11. The circuits 200 are all similar, so only the output circuit 200 that is connected to the output pin B0 of the switch chip 21 is described. A pin 1 of the photocoupler 30 is connected to the +3.3V power source via the resistor R1. A pin 2 of the photocoupler 30 is connected to the corresponding output pin B0 of the switch chip 21. A pin 3 of the photocoupler 30 is connected to the gate of the FET Q1 via the resistor R2 and grounded via the resistor R3. A pin 4 of the photocoupler 30 is connected to a +24V power source. The gate of the FET Q1 is also connected to the cathode of the voltage regulating diode Z1. The anode of the voltage regulating diode Z1 is connected to the anode of the voltage regulating diode Z2. The cathode of the voltage regulating diode Z2 is connected to the source of the FET Q1. The anode of the voltage regulating diode Z3 is connected to the source of the FET Q1. The cathode of the voltage regulating diode Z3 is connected to the drain of the FET Q1. The drain of the FET Q1 is connected to the output terminal OUT0, the cathode of the diode D1, and the anode of the diode D2. The cathode of the diode D2 is connected to the +24V power source. The anode of the diode D1 is connected to the cathode of the LED D11 via the resistor R4. The anode of the LED D11 is connected to the +24V power source. Elements of other output circuits 200 and related connection of the elements are same as the above-mentioned output circuit 200 that is connected to the output pin B0 of the switch chip 21.

The voltage regulating diodes Z1, Z2, and Z3 are used for regulating voltage. The diode D1 is used for rectifying. The diode D2 is used for regulating voltage. The LED D11 is used for indicating received signal state by a corresponding output terminal of the output terminals OUT0-OUT7. The voltage regulating diodes Z1-Z3, the diodes D1 and D2, and the LED D1 can be omitted to save cost.

The switch circuit 40 includes a switch chip 41 and a capacitor C0. Output pins B0-B7 of the switch chip 41 are connected to input pins DIN0-DIN7 of the CPLD 10. A ground pin GND and an output enable pin OE of the switch chip 41 are grounded. A voltage pin VCC of the switch chip 41 is connected to the +3.3V power source. An enable pin DIR of the switch chip 41 is connected to the +3.3V power source. A connection node between the voltage pin VCC and the enable pin DIR is connected to the ground via the capacitor C0. Each of input pins A0-A7 of the switch chip 41 is connected to a corresponding input circuit 300.

Each of the input circuits 300 includes two resistors R10 and R20, a diode D10, an LED D110, and a photocoupler 50. The circuits 300 are all similar, so just the input circuit 300 that is connected to the input pin A0 of the switch chip 41 is described as an example. A pin 1 of the photocoupler 50 is connected to the +24V power source. A pin 2 of the photocoupler 50 is connected to the anode of the LED D 110 via the resistor R20. A pin 3 of the photocoupler 50 is connected to the corresponding input pin A0 of the switch chip 41. The pin 3 of the photocoupler 50 is also grounded via the resistor R10. A pin 4 of the photocoupler 50 is connected to the +3.3V power source. The cathode of the LED D10 is connected to the corresponding input terminal IN0. The anode of the diode D10 is connected to the pin 2 of the photocoupler 50. The cathode of the diode D10 is connected to the pin 1 of the photocoupler 50. Elements of other input circuits 300 and related connection of the elements are same as the above-mentioned input circuit 300 that is connected to the input pin A0 of the switch chip 41.

The diode D10 is used for rectifying. The LED D110 is used for indicating received signal state by a corresponding input terminal of the input terminals IN0-IN7. The diode D10 and LED D110 can be omitted to save cost.

In use, the patch panel can be connected to the controller 700 via the connector J. When one output terminal, such as the output terminal OUT0, is connected to the peripheral device 500, the controller 700 outputs a control signal to the CPLD 10 via the connector J. The CPLD 10 sends the control signal to the pin 2 of the photocoupler 30 of the output circuit 200 connected to the output terminal OUT0, via the switch chip 21. The pin 3 of the photocoupler 30 outputs a high level signal (e.g., a logical one ) to turn on the FET Q1 and the LED D11 is lit up. The output terminal OUT0 outputs a signal to the peripheral device 500, such as a switch. The controller 700 controls the switch to open or close. Operation of the other output circuits 200 is the same as above.

When one input terminal, such as the input terminal IN0, is connected to the peripheral device 600, such as a sensor, the sensor outputs a low signal (e.g., a logical zero) to the input terminal IN0. When the input terminal IN0 receives the low level signal from the sensor, the LED D110 is lit up. The low level signal is provided to the CPLD 10 via the photocoupler 50 and the switch chip 41 in sequence. The CPLD 10 sends the low level signal to the controller 700 via the connector J. Therefore, the sensor can communicate with the controller 700. Operation of the other input circuits 300 is the same as above.

The controller 700 can communicate with many peripheral devices through the input terminals and the output terminals which are arranged on the opposite side surfaces of the patch panel to save space. Signal states of the input terminals and the output terminals can be indicated by the LEDs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A patch panel, comprising:
a connector to connect to a controller;
a first switch circuit;
a plurality of output circuits;
a plurality of output terminals, wherein each of the plurality of output circuits is connected to a corresponding output terminal of the plurality of output terminals, each of the plurality of output terminals capable of being connected to a peripheral device; and
a complex programmable logic device (CPLD) connected between the connector and the first switch circuit, wherein the CPLD is capable of receiving a control signal from the controller via the connector, and sending the control signal to one of the output terminals connected to the peripheral device via the first switch circuit, for signaling the controller to communicate with the peripheral device.

2. The patch panel of claim 1, wherein the first switch circuit comprises a switch chip and a capacitor, input pins of the switch chip are connected to corresponding outputs pin of the CPLD, a ground pin and an output enable pin of the switch chip are grounded, a voltage pin of the switch chip is connected to a first power source, an enable pin of the switch chip is connected to the first power source, a connection node between the voltage pin and the enable pin is connected to the ground via the capacitor, each of output pins of the switch chip is connected to a corresponding output circuit of the output terminals.

3. The patch panel of claim 2, wherein each of the plurality of output circuits comprises a photocoupler, first to fourth resistors, and a field effect transistor (FET), a first pin of the photocoupler is connected to the first power source via the first resistor, a second pin of the photocoupler is connected to a corresponding output pin of the first switch chip, a third pin of the photocoupler is connected to the gate of the FET via the second resistor and grounded via the third resistor, a fourth pin of the photocoupler is connected to a second power source, the source of the FET is grounded, the drain of the FET is connected to a corresponding output terminal and connected to the second power source via the fourth resistor.

4. The patch panel of claim 3, wherein each of the plurality of output circuits further comprises a first voltage regulating diode, a second voltage regulating diode, and a third voltage regulating diode, the gate of the FET is connected to the cathode of the first voltage regulating diode, the anode of the first voltage regulating diode is connected to the anode of the second voltage regulating diode, the cathode of the second voltage regulating diode is grounded and connected to the source of the FET, the drain of the FET is connected to the cathode of the third voltage regulating diode, the anode of the third voltage regulating diode is connected to the source of the FET.

5. The patch panel of claim 4, wherein each of the plurality of output circuits further comprises a first diode, a second diode, and a light emitting diode (LED), the cathode of the first diode is connected to the drain of the FET, the anode of the first diode is connected to a first end of the fourth resistor, the cathode of the LED is connected to a second end opposite to the first end of the fourth resistor, the anode of the LED is connected to the second power source, the anode of the second diode is connected to the drain of the FET, the cathode of the second diode is connected to the second power source.

6. The patch panel of claim 1, further comprising a second switch circuit, a plurality of input circuits, and a plurality of input terminals, wherein the CPLD is connected between the connector and the second switch circuit, each of the plurality of input circuits connected to a corresponding input terminal of the plurality of input terminals, each of the plurality of input terminals capable of being connected to a peripheral device, to receive a low signal from the peripheral device, wherein the input circuit sends the low signal to the CPLD via the second switch circuit, the CPLD sends the low level signal to the controller via the connector, for signaling the controller to communicate with the peripheral device.

7. The patch panel of claim 6, wherein the second switch circuit comprises a switch chip and a capacitor, output pins of the switch chip are connected to input pins of the CPLD, a ground pin and an output enable pin of the switch chip are grounded, a voltage pin is connected to a first power source, an enable pin is connected to the first power source, a connection node between the voltage pin and the enable pin is connected to the ground via the capacitor, each of input pins of the switch chip is connected to a corresponding input circuit.

8. The patch panel of claim 7, wherein each of the plurality of input circuits comprises a photocoupler, first and second resistors, a first pin of the photocoupler is connected to a second power source, a second pin of the photocoupler is connected to a corresponding input terminal via the first resistor, a third pin of the photocoupler is connected to a corresponding input pin of the switch chip, the third pin of the photocoupler is also grounded via the second resistor, a fourth pin of the photocoupler is connected to the first power source.

9. The patch panel of claim 8, wherein each of the plurality of input circuits further comprises a diode, and a light emitting diode (LED) connected between the first resistor and the corresponding input terminal, wherein the anode of the diode is connected to the second pin of the photocoupler, the cathode of the diode is connected to the first pin of the photocoupler, the anode of the LED is connected to the first resistor, the cathode of the LED is connected to the input terminal.

10. The patch panel of claim 6, further comprising a base board, wherein the plurality of input terminals and the plurality of output terminals are set on a first side surface of the base board, the connector, the CPLD, elements of the plurality of first and second switch circuits, elements of the plurality of output circuits and the plurality of input circuits are set on a second side surface opposite to the first side surface of the base board.
